(19) United States
(12) Patent Application Publication
(10) Pub. No.: US 2026/0105199 A1
(43) Pub. Date: Apr. 16, 2026

(54) INDUSTRIAL SYSTEMS DESIGN AND USE

(71) Applicant: 3M INNOVATIVE PROPERTIES COMPANY, St. Paul, MN (US)

(72) Inventor: John A. Merchant, Apple Valley, MN (US)

(21) Appl. No.: 19/114,871

(22) PCT Filed: Sep. 26, 2023
(86) PCT No.: PCT/IB2023/059504

§ 371 Date: Mar. 25, 2025

Related U.S. Application Data
(60) Provisional application No. 63/377,611, filed on Sep. 29, 2022.
(60) Provisional application No. 63/378,728, filed on Oct. 7, 2022.

(51) Int. Cl. G06F 30/12; G06F 30/20; G06F 111/04; G06F 119/08; G06F 119/18

(52) U.S. Cl. CPC G06F 30/12; G06F 30/20; G06F 2111/04; G06F 2119/08; G06F 2119/18

(57) ABSTRACT

An industrial process design system is presented that includes a process constraint retriever that receives an indication of a parameter constraint for an industrial process. The system also includes a parameter selector that retrieves a set of potential process design parameters for the industrial process. The parameter selector analyzes the parameter constraint indication, and based on the set of potential process design parameters, and constraint indication analysis, selects a next parameter of interest. The parameter selector also generates a constraint query for the selected next parameter. The parameter selector iteratively analyzes received parameter constraint information, selects a new parameter of interest, and generates a new constraint query. The system also includes a process design generator that generates a process design parameter set based on the constraint queries generated by the parameter selector.

### BACKGROUND

Many industrial systems have multiple parameters that are interdependent. Determining efficient parameter settings to achieve an acceptable process result presents ongoing challenges in many industries.

### SUMMARY OF THE DISCLOSURE

An industrial process design system is presented that includes a process constraint retriever that receives an indication of a parameter constraint for an industrial process. The system also includes a parameter selector that retrieves a set of potential process design parameters for the industrial process. The parameter selector analyzes the parameter constraint indication, and based on the set of potential process design parameters, and constraint indication analysis, selects a next parameter of interest. The parameter selector also generates a constraint query for the selected next parameter. The parameter selector iteratively analyzes received parameter constraint information, selects a new parameter of interest, and generates a new constraint query. The system also includes a process design generator that generates a process design parameter set based on the constraint queries generated by the parameter selector.

### BRIEF DESCRIPTION OF FIGURES

FIG. 1 illustrates an adhesive dispenser in which example embodiments can be implemented.

FIG. 2 illustrates a schematic of different variables of interest in an example adhesive dispensing operation.

FIG. 3 illustrates a process design cycle in accordance with some embodiments herein.

FIG. 4 illustrates a method of designing an industrial process in accordance with embodiments herein.

FIG. 5 illustrates a method of evaluating an industrial process in accordance with embodiments herein.

FIG. 6 illustrates a method of dynamically generating a parameter constraint request in accordance with embodiments herein.

FIG. 7 illustrates a process design system architecture in accordance with embodiments herein.

FIGS. 8-9 illustrate example user interfaces that may be presented to a process designer in accordance with embodiments herein.

FIG. 10 illustrates a process design system architecture in which example embodiments can be implemented.

FIGS. 11-13 illustrate example devices that can be used in embodiments herein.

### DETAILED DESCRIPTION OF ILLUSTRATIVE EMBODIMENTS

Many industrial processes use liquid materials such as adhesives, liquid food ingredients, coolants, or reaction products, to name a few examples. Certain properties of such liquids vary during a process operation—adhesives may cure, viscosity may change as temperature rises, a coolant may age and have a lower heat capacity than when initially purchased or installed.

Designing a new industrial process requires consideration of each of these properties and how they can be changed by adjusting process parameters. The design process is further complicated by the fact that, when designing an industrial process, the components themselves are also variables—e.g. a number of adhesives may be theoretically suitable for joining a metal component to a plastic substrate. Selecting which adhesive to use requires consideration of many factors—use conditions of the final product, required service life, etc.—in addition to the selection of dispensing operation parameters for that adhesive and/or its components.

Systems and methods herein are drawn to solving, or providing insight, into multivariate analysis problems of industrial process design. While the question of, for example, which adhesive is best for adhering a painted metal surface to a plastic surface, appears simple, many interdependent variables are at play. E.g., if that joint is on an airplane, it may need to have good adhesion over a wide temperature range. Similarly, the type or finish of paint may also impact adhesion of an adhesive to that surface.

While the example of adhesive dispensing is described throughout as one industrial process where systems and methods described herein may be particularly useful, is expressly contemplated that other industrial processes may also benefit from systems and methods herein.

Additionally, when referring to dispensing systems, the term “fluid” is broadly used herein to refer to a flowable substance. The flowable substance may be a liquid or a stream of solid particles, etc. In certain embodiments, a fluid is an adhesive. The adhesive may be a curable fluid adhesive. In some embodiments, a fluid is a curable two-part fluid adhesive. “Two-part” refers to the adhesive being composed of a first component and a second component which are mixed, e.g. in a static or dynamic mixer, to form the adhesive.

In other embodiments, the fluid is a void filler, a sealant, a dielectric fluid such as a 3M Novec™ engineered fluid, a thermally conductive interface material such as a thermally conductive gap filler, or a fluid chemical composition to produce any of the aforementioned fluids. However, other suitable fluid dispensing operations may also benefit from systems and methods herein.

A fluid has many properties that may be important to consider for industrial process design: viscosity, density, color, content of volatile components, water content, chemical composition, boiling point, but also ageing status, curing status in case of fluid curable compositions, or mixing ratio in case of the fluid being a mixture, to name only some. Some of these properties are interdependent. For example, a viscosity changes with temperature. Some of these properties are independent, for example a color of a fluid may be set and not adjustable, for example by use of additives. While many examples herein contemplate liquids, it is also expressly contemplated that flowable solids, a flow of solid material (e.g. particles, particulates, etc.) or gases may be present in some systems.

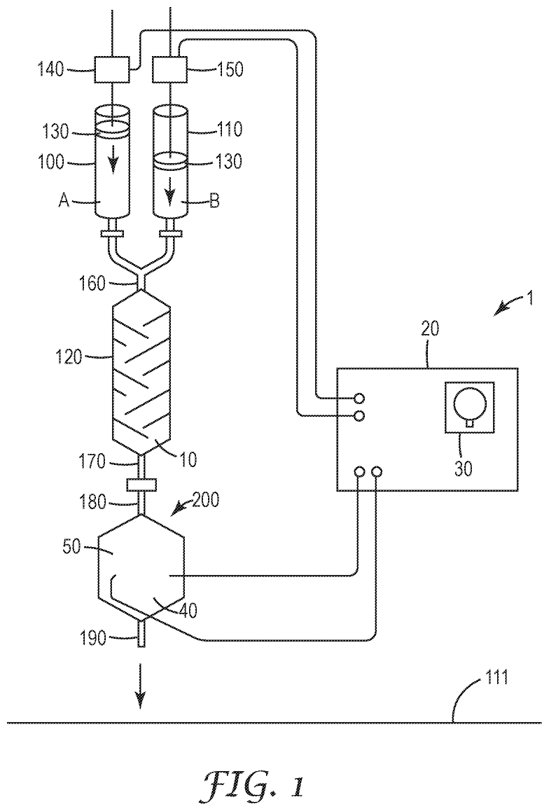

FIG. 1 illustrates an adhesive dispenser in which example embodiments herein may be particularly useful. FIG. 1 is a side view of a dispenser and mixing system 1 for a viscous two-component adhesive. First component A and second component B are pushed out of respective cartridges 100, 110 into and through a static mixer 120. In the illustrated system 1, at the output 170 of the static mixer, the mixed adhesive passes through a sensing area 50 before being dispensed at the output 190. Sensing area 50 may house a sensor that senses a mixing ratio, temperature, viscosity, or other variable(s) of interest of components A and B in the mixed adhesive. Feedback from sensing area 50 may be important in verifying preferred process parameters.

The cartridges 100, 110 contain the viscous components A and B, respectively. A respective piston 130 is moved further into the cartridge 100, 110 and pushes the component A, B out. The pistons 130 are driven by respective motors 140, 150 which are individually controllable, and the pressure generated by the pistons 130 moves the unmixed components and—after mixing—the mixed viscous adhesive 10 through the static mixer 120 and the channel 20 of system 1. The motors 140, 150 may be part of a feedback loop: if a sensed mixing ratio is outside an acceptable band of desired mixing ratios, the motors 140, 150 can be individually controlled such as to push more of component A and/or less of component B (or vice versa) into the static mixer 120 in order to adjust the mixing ratio towards the desired mixing ratio. Both motors 140, 150 can be controlled separately to obtain a desired total throughput per second of mixed adhesive to be dispensed.

The static mixer 120 receives the unmixed components A and B of the two-component adhesive at an input end 160. Lamellae inside static mixer 120 redirect the flow of the input materials many times and introduce shear forces that help mix the components A and B with each other. The output end 170 of the static mixer 120 is connected to an inlet 180 of a duct piece 190 containing the channel 20 and sensing zone 50. The mixed adhesive 10 can thus exit the static mixer 120 and enter the duct piece 190. At the outlet 190 of the duct piece 190, the mixed adhesive 10 is dispensed.

Sensing area 50 may include one or more different sensors that detect properties of one or more of components A and B, and the resulting mixture. For example, mixing ratio, temperature, viscosity, flow rate, etc. However, it is expressly contemplated that sensors may be positioned elsewhere in the system, and that other sensors may be important. Sensed parameter information may be provided to a control system 20. Control system 20 may be specific to dispensing system 1, e.g. in that it changes flow rates, temperature, etc. for the dispensing system. However, it is expressly contemplated that control system 20 may also how is embodiments herein. Control system 20 may contain internal memory 30 such as calibration data, etc.

Accurately dispensing a multipart adhesive onto a surface, such as substrate 111, is a difficult problem in itself, ensuring an appropriate mixing ratio, temperature, speed of movement of dispenser with respect to surface 111, etc. This problem is further complicated when an industrial process is first designed. For example, adhesive may be dispensed onto substrate 111, such that substrate 111 can then be joined to a second material (not shown). The composition of substrate 111, the second material, and the use of those two materials are all important for determining which adhesive a dispensing system should dispense, in addition to the dispensing parameters.

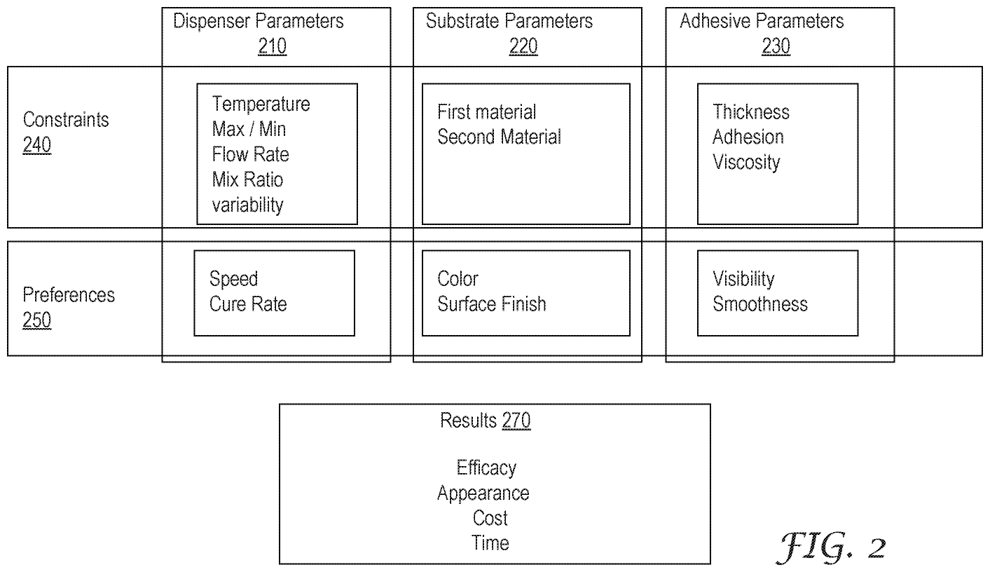

FIG. 2 illustrates a non-exhaustive schematic of parameters that may need to be considered when designing parameters of a dispensing system. For example, a dispensing system may have dispenser parameters 210 such as state operating temperature, possible flow rates, sensitivity detection with respect to mixing ratios, etc. Substrates may also have parameters of interest 220, for example a material composition of the first and second material being joined. An adhesive, or other dispensed fluid, may also have fluid parameters 230 such as a thickness and adhesion to the first material, adhesion to the second material, viscosity when dispensed, etc.

Parameters of interest are divided into constraints 240 and preferences 250. Constraints 240 refer to parameters that are limited based on the specified design problem. For example, a customer may only have access to a particular dispenser, which may have a maximum and/or minimum flow rate. Additionally, properties of the substrates may also be set in place, based on the substrate selected by the customer. However, a customer may also have a number of preferences 250, e.g. for the industrial process, such as a dispensing speed, a cure rate, a final color of the dispensed fluid, smoothness of the fluid on the first or second material, whether or not the dispensed is visible, etc.

Additionally, a third set of parameters of interest concern the final resulting product, classified as results 270 in FIG. 2. For example, the dispensed adhesive has to be effective for the application of interest, often with a maximum cost, and dispensed and cured within a suitable timeframe.

Currently, selecting an adhesive for an industrial process often requires consulting an application engineer, or other expert in the space. Many of the parameters illustrated in FIG. 2 are interdependent, for example a particular adhesive may work well on metal, well on glass, and may bond metal to glass indoors, but will fail if used outdoors because of thermal expansion differences in the flexibility and relaxation characteristics. Attempts have been made to reduce the cost of designing industrial processes by providing automated assistance to customers. However, it is difficult to capture intricacies in the interdependence of parameters without presenting, or requesting, so much information that a customer is frustrated.

Systems and methods described herein rely on machine learning trained models driven by a data set of known adhesive parameters and substrate interactions such as the glass-metal example provided above. Using systems and methods described herein, an algorithm selectively queries a customer for information about the desired final product and provides recommended industrial process parameters.

An important limitation to standard multi-variate algorithms (regression, nearest neighbor, etc.) is that they treat each variable with equal significance. This may be done by normalization, or a principle component reduction of dimensionality, in which individual factor priority is lost to a greater extent. An improvement to these models is to add factor prioritization. This can be done in a number of ways such as weighting factors and ordered questions.

For example, for some processes, price and speed are more important than a final product color, and may be worth a reduction in possible adhesion. For other processes, an ability to withstand extreme temperature changes will override a cost constraint. While color may be of interest to a customer, it may not even be provided as a constraint query because other parameter requirements will override and dictate a color of the final product.

Even when an application engineer is involved in the designing of an industrial process, it is often important to actually produce a test adhesive, or fluid of interest, to test the efficacy and make sure that constraints are met.

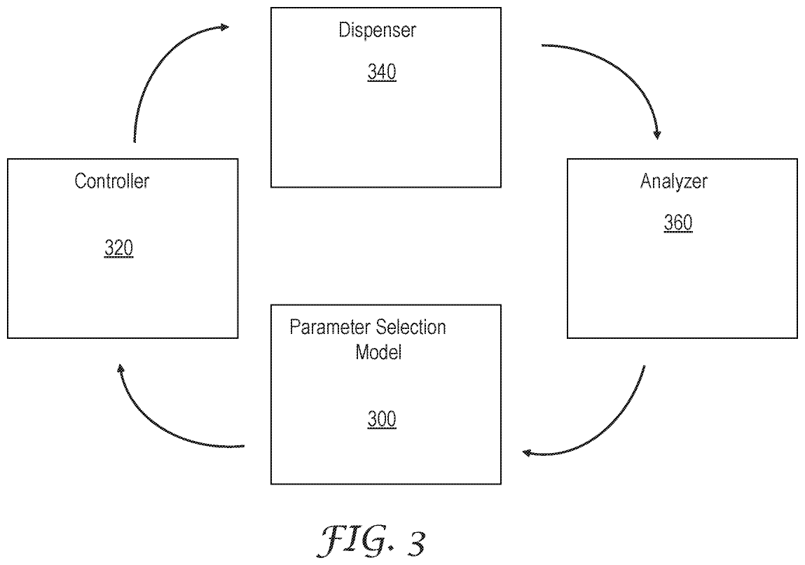

FIG. 3 illustrates a process design cycle in accordance with embodiments herein. It is expressly contemplated that, for many industrial processes, an iterative approach is required to determine all suitable process conditions. Therefore, a parameter selection model 300 may provide an initial selection of process parameters—such as a selected adhesive N consisting of a Component A and Component B at a mixing ratio X:Y. This information may be provided to a controller 320 which dictates settings of, and actuates, dispenser 340. Dispenser 340 then operates at the designed specifications to produce a dispensed fluid on a substrate. Analyzer 360, which may be based on human input, sensor input, or a mixture thereof, provides an indication of whether the dispensed fluid was suitable, which constraints were not met, etc. This information is then provided to parameter selection model 300, which may then change one or more process parameters. For example, a selected adhesive may remain the same, but a mixing ratio may be adjusted, or a dispensing temperature may be adjusted such that a desired viscosity is achieved.

Parameter selection model 300, in some embodiments herein, is a machine learning driven algorithm that accesses and uses a database in order to determine constrained parameters of interest, and interacts with a customer to set values of said parameters of interest. Models are limited by the data set behind them, which includes a combination of database limitations, e.g. key value databases versus object oriented databases, and the need to discreetly assign characteristic values to attributes. For many current databases, once these characteristic values are set, they must be changed manually if change is required. And, depending on the complexity of the model, adjusting one value may require adjusting other values to maintain model output quality.

It is desired to have a feedback loop with an automatically adjusting algorithm that removes the need to explicitly set, and change, every weighted value. Because of the limitations of multivariate algorithms, decision tree models may be considered. Depending on the complexity of the inputs and outputs this may work well, especially if there are a small number of linearly independent variables. However, as the number of variables increases, and the number of output options increases, it is difficult to keep the tree updated appropriately. If there are any interactions between variables, this task becomes very difficult. Often, any change such as adding a new product (e.g., a new potential adhesive) to the database, or removing a value (e.g. a heater is broken and temperature can no longer be changed) will result in a need to totally reconstruct the decision tree. Using machine learning techniques, it is possible to design a decision tree trained by expert knowledge of inputs and outputs such that a model can update algorithmic connections on its own as new data is provided. For example, every time the cycle of FIG. 3 is undertaken, new data can be added to a database that then can be used to improve the model.

In some embodiments, a parameter selection model may be communicably coupled to an automated adhesive compounding system such that samples of a specified adhesive composition can be automatically created with little to no interaction from the user. However, it is also expressly contemplated that the model may also output process conditions, which a customer may then have to implement manually or set in a semi-automatic manner.

Similarly, as discussed herein, analyzer 360 may be automated, such that sensors can detect an amount of adhesive dispensed, thickness of the adhesive, appearance of the adhesive, smoothness of the adhesive, as well as performance information regarding the adhesive e.g. whether or not two materials were in fact sufficiently adhered together. However, it is expressly contemplated that at least some of this provided feedback may need to be entered manually by a user. Therefore, in some embodiments, analyzer 360 also includes an I/O component that interacts with the user to obtain feedback. Received feedback, either manually from a user, or through automated sensing, can then be incorporated into the model to improve future suggestions. The model can be extended at any level to include suggestions for use which could include suggesting systems for automation of the adhesive or dispensing operation.

In a model training phase, inputs can be taken from a variety of sources including structured or unstructured data. Structured data could include, for example, a database of physical properties, or experimental results, spreadsheet files, flow charts, decision trees, etc. Unstructured data could include written or verbal explanations/commentary, Q&A type discussions or pieces of data that have yet to be placed in a structured format (like a data sheet PDF that states in a sentence that the maximum operating temperature is X. Such data, in its current form, would be unstructured, but that same info in a database or chart could be considered structured data. Similarly, conditional statements, such as use instructions that say “for wood, prep surface like this and for metal prep it like this,” etc. would also be classified as unstructured. However, these examples are provided as exemplary instances of structured and unstructured data and are not intended to limit those terms.

The system would understand these data in the context of whatever inputs are given to further enhance capabilities. In some embodiments, in addition to, or instead of, sending a sample with the suggested process conditions, the model can integrate entering information about the user along with existing records both public and internal. For example, based on salesforce.com information, a model may be able to make an assessment about whether human intervention, e.g. a sales representative, technical assistance, or an application engineer, should be sent to the user.

Systems and methods herein provide a customer with recommended process conditions in order to obtain a desired result. For example, a proposed adhesive may be designated, which may be formed from one or more designated components, at a designated mixing ratio, dispensed at a certain flow rate and temperature, etc. A Finite Element Analysis (FEA) based on an Material Data Card may be done, and iterated until satisfactory results are provided. Because measuring and estimating quality is difficult, systems and methods herein may be used as a first step to suggest potential adhesive products for modeling using FEA software. However, it is expressly contemplated that an MDC could estimate adhesion as well as bulk strain.

In some instances, it is possible that customer-provided constraints provide no options that the model deems feasible. The model may then suggest properties that would be present in a desired adhesive, if it existed. This may be then used to start a new product introduction program to create such an adhesive. In some embodiments, systems and methods herein may suggest formulations of the specified adhesive based on known formulations. This may include interpolating existing adhesives and adhesive technology.

In some embodiments, systems and methods herein can extrapolate beyond currently existing products to suggest new adhesive formulations for testing.

In some embodiments herein, the model can enter a training mode and receive new information and new constraint query possibilities, for example from a subject matter expert. For example, a new adhesive formulation may be added which may be useful for a new substrate, which may result in a new constraint query. For example, the model may never have been used for a substrate exposed to extreme cold, however this may be an important feature for a new project.

In some embodiments herein, the model is capable of conversing with a user using natural language input. This may improve model training, as an expert may be able to converse with the model, instead of having to sit down and reprogram it. For example, an expert may communicate “that's an okay product suggestion, but you didn't ask about price limits. If you consider price limits for this market, the best option is product X.” The model may then incorporate a new constraint query regarding pricing. The pricing constraint may then be related to previous inputs, and particularly the market of concern. The newly introduced product X may then be assigned by the model as the best option under the given constraints going forward.

However, while natural language input may be preferable, it is expressly contemplated that the model may also be programmable using another suitable I/O component, such as a keyboard, mouse, touchscreen, button, or other suitable system.

It is also contemplated that in some embodiments, the model may incorporate multiple different data types, e.g. categorical, numeric, Boolean, etc. The model may be able to recognize the datatype as well as the specialize handling needed by the model.

Particularly in the field of adhesive formulation selection, there may not be a “right” answer. For example, not all information may be available for a model to make a best choice among a set of suitable choices. Consider the problem of bonding a material to ABS, which has a huge range of adhesion issues. Systems and methods herein may represent an improvement over decision trees for such a scenario. Particularly when there is conflicting info, e.g. a customer wants a product to be black, and it has to stick to ABS. There may be a great product that sticks to ABS, and no suitable black adhesive for ABS. The method may go back to the customer and ask whether gray is suitable, or it may just weigh the substrate more heavily because the adhesion almost always is more important than the aesthetic.

As illustrated in FIG. 2, some parameters (e.g. constraints) may be weighed differently than others (e.g. preferences). For example, adhesion is almost always a priority over color and desired thickness. It is also contemplated that the model may learn, based on the use of the final product, for example, that different parameters should be weighed differently in different contexts. For example, smoothness of the dispensed adhesive may not be important, except in a product where aesthetics are of concern. In another example, thickness may not be of particular concern, with adhesion being a higher priority, except potentially in a situation where a final weight, height, etc. must be precise. However, it is expressly contemplated that a model may determine that, for a particular process, a preference (e.g. speed or cost) should be prioritized.

The model may classify different parameters in different ways. For example, an adhesive may either be clear, or black, but cannot be both simultaneously. In another example, an adhesive may have a first viscosity at one temperature, a second viscosity at a second temperature, and cannot have that second viscosity at the first temperature. Parameters may be classified as categorical e.g. falling into a number of options such as gray, black, or clear. Parameters may also be classified as numerical, e.g. thickness or temperature is expressed as a number, such as 1.2 or 70° F. Parameters may also be classified as Boolean parameters, where there are just two options, e.g. true or false, etc. A nonexhaustive list of some example classifications are provided below in Table 1.

TABLE 1
Example Constraint Classification

| Classification | Example |
|---|---|
| Mutually | An adhesive may be either white or black in color, but it may not be |
| Exclusive, | both. If the user indicates one, it must not be the other. |
| Categorical | |
| Non- | Adhesive Strip 1 may be resistant to water and oil while Adhesive Strip |
| Exclusive, | 2 may be resistant to water but not oil. If the user needs oil resistance, |
| Categorical | then only Adhesive Strip 1 is an option, but if the user needs water |
| | resistance, then both tapes may be considered. |
| | If the user indicates a negative for oil resistance, then it would be an |
| | error to remove Adhesive Strip 1. A naive Boolean categorization |
| | would lead to elimination of Adhesive Strip 1 with the information that |
| | oil resistance is not wanted when in fact the user is communicating that |
| | there is no preference for or against oil resistance. |
| Closest Fit, | An adhesive strip (or tape) has a set thickness and a user may indicate |
| Numeric | a need for a specific thickness. In this case, the model must judge how |
| | important it is to match the user-requested thickness and also quantify |
| | the goodness of fit. |
| Hybrid, | An adhesive may thermally decompose above a given temperature. The |
| Numeric | user may indicate a desired maximum temperature for the application |
| | which could alternatively be treated as a number with a goodness of fit |
| | calculation (if high, but not over the limit) or as a categorical Boolean |
| | if over the limit (where it must be removed from consideration), or it |
| | could be ignored if the temperature given is low enough that it is not |
| | interesting for any product still under consideration (i.e. the user |
| | indicates maximum temperature of 25° C. and this is the default |
| | temperature for all products' performance measures). |

It is expressly contemplated that some products under consideration may need to be treated categorically at the same time that others are treated numerically. All of this can be incorporated into an appropriate algorithm.

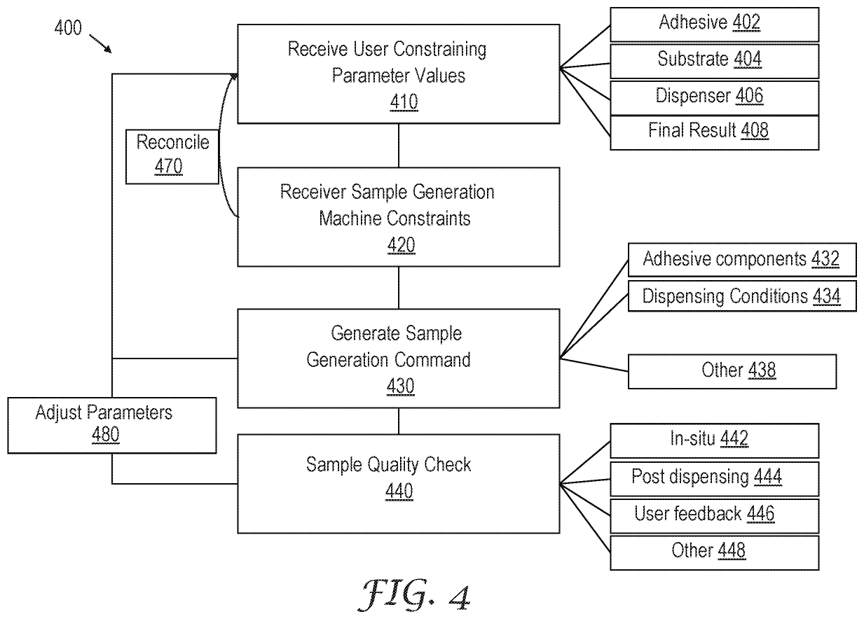

FIG. 4 illustrates a method of designing an industrial process in accordance with embodiments herein. The steps of method 400 may be performed locally, for example by a controller of an adhesive formulation machine. However, it is expressly contemplated that at least some of the steps of method 400 may be performed remotely.

At block 410, the model receives constraining parameter information. For example, constraining parameter may relate to an adhesive 402, a substrate 404, to dispenser 406, or a final product result 408. For example, adhesive constraints may relate to a type of substrate 404, or to use conditions that the adhesive 402 needs to withstand. For example, the adhesive 402 may be used under high heat, may need to withstand low temperatures, may need to withstand a range of temperatures without significant thermal expansion, etc. Constraining parameter information may include values—e.g. a maximum or minimum flow rate for a dispenser 406, as well as other information—e.g. whether component X is in stock, etc.

As described herein, it is expressly contemplated that a model may select constraint queries to present to the user based on previously received information, either from the user or another source. Therefore, the operation in block 410, may be considered as a series of constraint queries presented by the model to a user. The model may start with, for example, use conditions for final product, substrate materials, and then may proceed to select queries based on the information received. For example, if all black adhesives are eliminated based on use conditions, color-based constraint queries will not be presented to a user. Similarly, if dispenser 406 does not have a heating element, any constraint queries about high or low temperature process conditions will not be presented to a user.

Similarly, in the operation of block 420 constraints may be received from a sample generation machine. For example, if sample generation machine is out of component A, then method 400 may proceed to block 480 and obtain additional parameter constraints to find a set of process conditions that do not require component A.

In the operation of block 430, a sample is generated based on the process conditions selected by the model. The process conditions may include, for example, adhesive components 432, dispensing conditions 434, such as a temperature, a flow rate, a mix ratio, speed, etc. The process conditions may also include other conditions 438.

In the operation of block 440 the quality of the generated sample is checked. For example, the adhesive may be dispensed onto a substrate of interest, and adhesion may be tested. Quality checking, in block 440, may also include quality checking the dispensing of the adhesive itself, for consistency of flow, gaps, consistent thickness, smoothness, etc. Quality checking may be done in situ 442, or after the dispensing operation is finished 444. Additionally, in at least some embodiments, user feedback 446 is provided to the model. User feedback 446 may include feedback communicated to the model in any suitable way, for example natural language input, I/O input device, or through any other suitable mechanism. User feedback may include whether the sample behaved as expected, whether the sample was suitable for the operation, or what parameters need to change. For example, adhesion may need to be increased on a substrate, the adhesive needs to be less viscous at the dispensing temperature, etc.

As illustrated by the operation of block 480, based on the results of sample testing, method 400 may proceed back to generating a new sample in block 430, based on identifiable changes, or may proceed to the operation of block 410 to obtain additional constraining information from the user. For example, in some embodiments, the adjustment to process conditions may be remedied by a dispensing condition change such as increase in flow rate or temperature. However, in other embodiments may be necessary to restart the constraint query process.

Systems and methods herein have been described with respect to the problem of generating process conditions for an adhesive dispensing operation. However, it is expressly contemplated that systems and methods herein may also be used for other suitable industrial processes with interdependent parameters. Any industrial process where a multivariable analysis is needed to generate process conditions may benefit from method 400. For example, selecting an abrasive article for use on a particular substrate may involve consideration of multiple factors. In addition to which hand tool to use with which abrasive article, whether or not the abrasive article should be used dry, with a polished, with water, etc. Similarly, the process of generating other materials, such as an adhesive strip (e.g. a tape) with or without a liner, may also benefit from systems and methods herein.

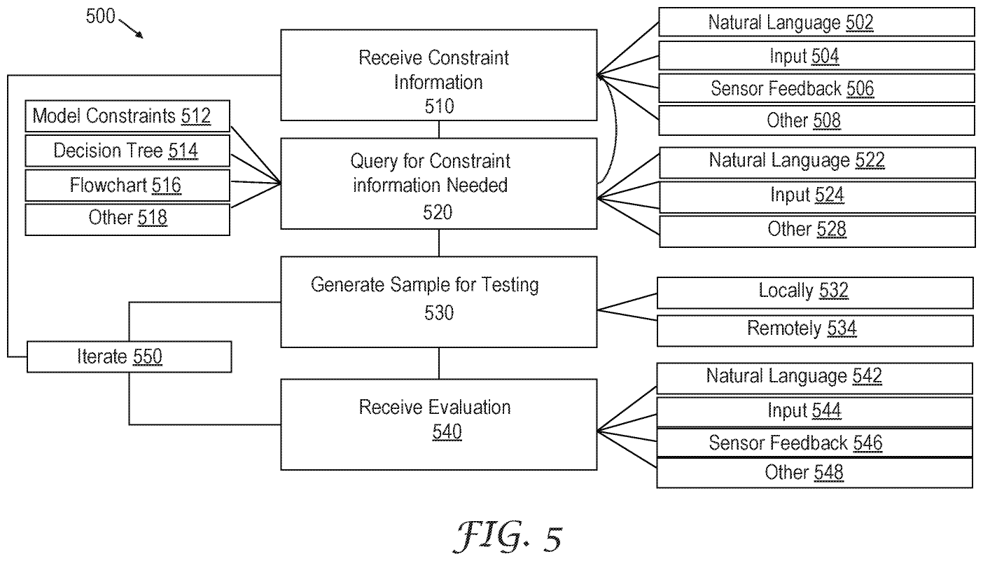

FIG. 5 illustrates a method of evaluating an industrial process in accordance with embodiments herein. Method 500 illustrates how a model may interact with a user.

At block 510 constraint information for a process is received. The constraint information may be received in a natural language format 502, as an input through an I/O device 504, received through sensor feedback 506, or any other suitable mechanism 508.

At block 520, constraint information is requested from a user. Constraint information may be queried using a natural language interface 522, such as a smart phone assistant, or other interface, or another suitable I/O device 524 may be used, such as a touch screen, keyboard, mouse, etc. However, other suitable methods 528 for sending and receiving constraint queries and responses are also envisioned. For example, a series of constraint information queries could be sent via text message, a messenger app, or another suitable communication method. The operations in blocks 510 and 520 may happen simultaneously or in reverse order to that illustrated in FIG. 5, e.g. at least one query may be generated prior to any constraint information being retrieved.

Constraint queries may be generated based on constraints identified by the model 512. For example, the model may determine that a number of adhesives may be suitable and may generate a constraint request to determine which might be a best fit. The best fit may be based on a price constraint, a substrate, a temperature range of use, a temperature range during dispensing, or any other suitable constraint.

A query can also be generated by the model following, at least in part, a decision tree 514. For example, a first query may ask for a first substrate material, and a decision tree may then indicate that the next query should be for a second substrate material. A query can also be generated by following a flowchart 516, for example first obtaining substrate materials, then obtaining process conditions, etc. However, it is expressly contemplated that a query may be generated in other suitable ways 518. As described herein, the model may select constraints 512 is based at least in part on machine learning based training, such that generating a query in block 520 is at least in part dynamic, such that a user does not necessarily answer the exact same series of queries each time a process is designed.

At block 530, a sample for testing is generated. The sample may be generated automatically, for example by sending instructions to an automated sample generation machine, the instructions including the process conditions selected by the model. However, at the other end of the spectrum, generating a sample for testing in block 530 includes instructions for a user to set up an industrial process to generate a sample for testing. The sample may be generated locally, by a device in direct communication with the model, as indicated in block 532. However, it is also envisioned that the model is run on a processing device remote from a sample generation system, in some embodiments.

At block 540, an evaluation is received, for example based on testing of the generated sample. The evaluation may be received in any suitable manner including, but not limited to, a natural language interface 542, and I/O device 544, sensor feedback 546, or another suitable option 548.

At block 550, the process is iterated until a suitable set of process conditions is identified that achieves the desired properties of a user. Iterating may include returning to block 530 to generate a new sample for testing, and/or may include returning to block 510 to obtain new constraint information. For example, in some embodiments, a user's desired specifications may change based on the results of sample testing.

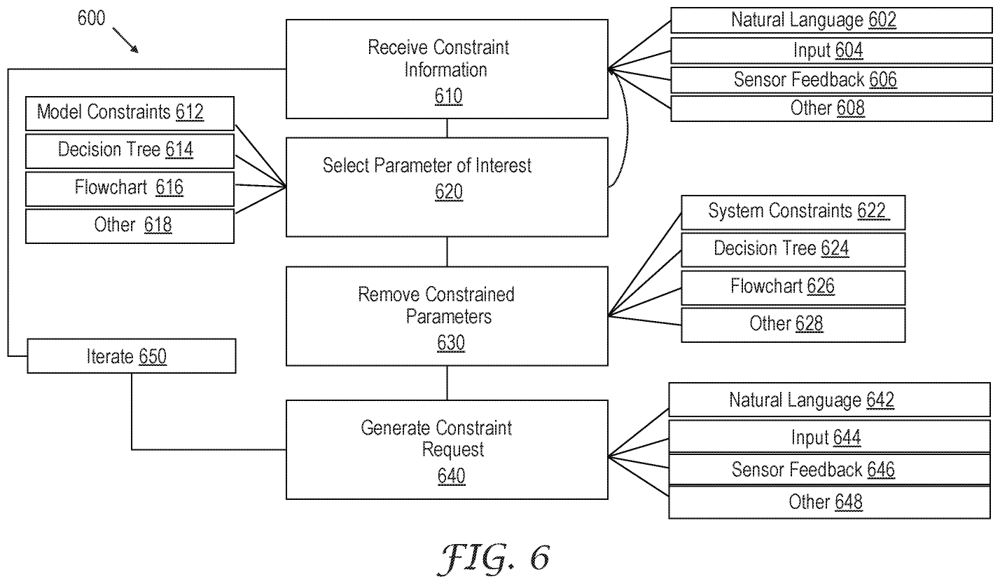

FIG. 6 illustrates a method of dynamically generating a parameter constraint request in accordance with embodiments herein. Systems and methods are described herein that include a machine learning based model that a user can interact with in order to select process conditions for an industrial process. It is expressly contemplated that the model, in embodiments herein, can dynamically generate a request for information, or a constraint request, based on information provided by the user, in order to efficiently reach a set of process conditions. For many industrial processes, such as adhesive dispensing discussed herein, there are not always a one-to-one correlation of process conditions to desired output. Therefore, it is envisioned that in embodiments herein the model will dynamically generate constraint queries based on a current set of known datapoints in an attempt to find a best fit of process conditions. Method 600 may be used by systems and methods herein to dynamically generate a constraint request.

At block 610 constraint input is received by the model. The constraint input may be received by a natural language interface 602, and I/O device or other user input device 604, sensor feedback 606, or in another suitable manner 608. For example, in some embodiments, some constraint input may be retrieved from a data store based on known process information, e.g. a known dispenser model may dictate a maximum flow rate, and temperature constraint information.

In block 620, a next parameter of interest is selected. Based on known information, the next parameter of interest is dynamically selected. Determining a next process variable may be done in conjunction with block 630, discussed below, before block 630, or after block 630. The next variable of interest may be directly requested to a user, or provided as one of several options for a user to select from, or may be dictated by one or more constraint selection algorithms. For example, if system limits 612 for one or more parts of the industrial process are not known, those may be necessary in order to determine that a set of process conditions fall within an acceptable range. In some embodiments, the model may consult a decision tree 614 order to determine what the next parameter of interest is. For example, if cost information has not yet been determined, a decision tree may indicate that cost information should be requested before final product color preferences, for example. Similarly, in some embodiments, a flowchart 616 may indicate an initial order of importance for different parameters of interest. However, it is expressly contemplated that that initial order may change based on constraint information received from a user.

At block 630, one or more parameters may be removed from consideration. For example, based on known constraints, the only adhesives of interest may all be one color, so a color parameter may be removed from consideration. Fixed parameters may not be presented to a user, in some embodiments. However, it is also expressly contemplated that fixed parameters may be presented to a user, such that the user is aware that those parameters are dictated by previously received constraint information. Another example of a fixed parameter may be a temperature threshold based on input that a dispenser does not have a heating element. Therefore, it is not possible to adjust a dispensing temperature, or to vary a viscosity using temperature. The model may classify one or more parameters as a fixed parameter based on received information about the system 622, based on one or more steps of a decision tree 624, based on steps in a flowchart 626, or using other suitable techniques 628.

At block 640, a constraint request is generated. The model may determine that a best fit has not been selected based on remaining parameters of interest. A constraint request may be generated based on the next parameter of interest. For example, if the next parameter of interest is a cure time, the constraint request generated at block 640 may be a natural language query 642 asking if a customer has a maximum cure time allotted. The constraint request may also be communicated another suitable way is, for example using an I/O user input device 644, by querying and receiving sensor feedback 646, or using another suitable alternative 648.

The model may then return to block 610, as indicated by iteration operation 650, when a response to the constraint request is received.

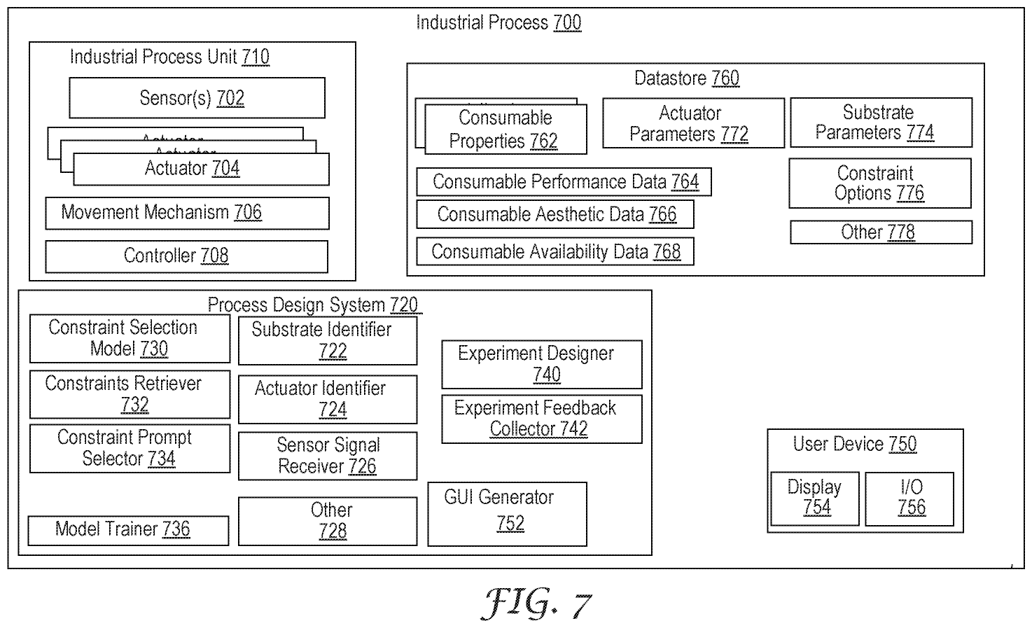

FIG. 7 illustrates a process design system architecture in accordance with embodiments herein. Industrial process 700 may be any suitable process with multiple interdependent parameters. For example, an abrasive operation may involve consumable abrasive articles contacting and abrading a surface of the substrate. Additionally, as described herein, an adhesive dispenser may dispense a formulated adhesive composition onto a substrate. Other industrial processes are also envisioned.

Industrial process 700 includes an industrial processing unit 710. Processing unit 710 may be any unit operation that causes a consumable article to contact a substrate; e.g. a dispenser of an adhesive, a robot arm coupled to an abrasive article, etc. Industrial process unit 710 may include one or more sensors 702 that provide information about any of: industrial process unit 710, a substrate, a consumable article, the ambient environment, a state of one or more components of the industrial process unit 710, or other information that may be relevant to a process design system 720. For example, sensor 702 may include a position sensor that provides a detected distance between a dispenser tip and a substrate.

In another example, sensor 702 may be in communication with a first control unit of a robotic abrading system and may provide an indication of an applied force on a substrate surface, a speed of rotation, etc.

Industrial process unit 710 may be a stationary unit or may have one or more movement mechanisms 706. For example, in the fluid dispensing context, movement mechanism 706 may move a dispenser with respect to a stationary substrate, or move the substrate with respect to a stationary dispenser. Additionally, movement mechanism 706 may move the dispenser closer to, or further away from, a surface of the substrate.

Industrial process unit 710 includes a controller 708, that controls one or more actuators 704. An actuator 704 as described herein, is intended to broadly cover any part of industrial process unit 710 that can take an action. For example, an adhesive dispenser may dispense any of a first component A, a second component B, an additive, or combination thereof, each of which may have an individual actuator 704 associated with dispensing and controlling said flow rate.

A user of industrial process unit 710 may need to select parameter values for a new process. For example, a dispensing line may need to be reconfigured to dispense a different adhesive. Or one or more components of an adhesive may be out of stock, and a new adhesive formulation needs to be selected to address the shortage. Process design system 720 may interact with a user, for example through a user device 750. User device 750 may have a display 754 as illustrated in FIG. 7, however it is expressly contemplated that a display is not needed for every embodiment, and the user can use a natural language feeding interface, or another suitable I/O device 756.

Process design system 720 utilizes information from data store 760, which may be populated from previous experiments and/or application engineer knowledge, or another suitable source of data, to select operational parameter values for controller 708 to implement. Process design system 720 is a dynamic system that, based on information retrieved from data store 760, or other sources, generates queries for a user in order to select a set of process parameters for the industrial process unit 710.

Constraint selection model 730 is a machine learning-powered algorithm that generates a query for a user of the industrial process unit 710. Constraint receiver 732 receives information about an operation to be conducted by industrial process unit 710. Information may be received from sensor 702, for example, from data store 760, or through communication with the user directly, e.g. using user device 750. Received constraints may include, for example, a current position of a robotic arm with respect to a substrate, a current component A and component B loaded into adhesive dispensing units, an ambient temperature, etc.

Constraint selection model 730 analyzes constraint information received by constraint retriever 734, and determines a next parameter of interest to design the process for unit 710. E.g., based on received constraint information, an adhesive composition may be set, but a flow rate and temperature may yet be undetermined. Model 730, therefore, may ask a customer about a process rate (e.g. how fast should adhesive be dispensed/how many adhesive operations should be completed during a shift?) to obtain the constraint information needed to set those parameter values.

In some embodiments, process design system 720 may also include a substrate identifier 722, and/or an actuator identifier 724. Substrate identifier 722 may detect a substrate that process unit 710 will act on. For example, one or more of sensor 702 may include an optical unit that images and identifies a substrate. However, substrate identifier 722 may identify a substrate by accessing data store 760, for example. Once a substrate is known, a substrate parameter 774 for the industrial process unit 710 can be retrieved. Similarly, in some embodiments, actuator identifier 724 may communicate with controller 708 of industrial process unit 710, to identify industrial process unit 710.

Identifying process unit 710 may include identifying a type of process unit 710, for example a robotic arm versus a dispensing unit, as well as a make and/or model in order to retrieve parameter constraint information, e.g. a temperature range, movement speed range, etc. However, while substrate identifier 722 and actuator identifier 724 are illustrated in FIG. 7 as part of a process design system 720 that automatically identifies a substrate and a process unit 710, it is expressly contemplated that, in some embodiments, a user may have to manually communicate that information to process design system 720.

In some embodiments, process design system 720 also includes a sensor signal receiver 726, which may receive information from sensor 702. However, sensor signal receiver 726 may also receive sensor information from a data store 760. Sensor signals may be received in real-time, delayed, or only from a previous operation of process unit 710.

Constraint prompt selector 734, based on analysis by constraint selection model 730, selects a prompt or query to be presented to a user, for example using user device 750. For example, if it is determined that viscosity is a parameter of interest, constraint prompt selector 734 may retrieve a constraint option 776 from data store 760, such as a minimum viscosity, a maximum viscosity, and acceptable viscosity range, etc.

Process design system 720 may also have other components 728 as well. For example, in embodiments where process design system 720 communicates with the user device 750 that includes a display 754, a GUI generator 752 may generate a GUI for presentation on display 754.

Process design system 720 may also include a model trainer 736, that, based on user feedback, adjusts constraint selection model 730. As described herein, in some embodiments constraint selection model 730 may interact with an application engineer or other expert in the space during a training phase, such that model 730 can learn which parameters are of greater interest in different scenarios.

In some embodiments, constraint selection model outputs process parameters for industrial process unit 710, however additional experimentation may be useful for industrial processes where interdependence of parameters is hard to predict. For example, in the adhesive space, it may not be possible to have enough information within data store 760 to be completely sure that a particular set of process parameters will achieve the desired performance, aesthetics, or other customer needs. Therefore, in some embodiments an experiment designer 740 may generate a set of process parameters for testing, for example on industrial process unit 710, or on a different system. Experiment feedback collector 742 may collect results. For example, experiment designer 740 may communicate directly with an industrial process unit 710 to implement the process control parameter values selected by constraint selection model 730. However, it is expressly contemplated that experiment designer 740 may also communicate with GUI generator 752 to present instructions on display 754 for a user to conduct the experiment on their own.

Datastore 760 may include any information relevant to constraint selection model 730. Consumable properties 762 may include any properties about a consumable used by industrial process unit 710. For example, a robotic abrading system may benefit from a datastore 760 that includes, for a number of abrasive articles (e.g. bonded abrasive articles, nonwoven abrasive articles, coded discs, or other suitable abrasive articles), consumable properties 762 such as a cut rate and a service life for each abrasive article.

For individual consumables, datastore 760 may include data regarding performance 764, such as an adhesion of an adhesive, or a cut rate of an abrasive article. Datastore 760 may also include aesthetic data 766, such as a color of adhesive when cured, a smoothness of adhesive when cured, etc. Additionally, datastore 760 may include availability information 768, which may include pricing information as well as whether or not said consumable is currently in stock. In some embodiments, process design system 720 may disregard availability data 768, if it is indicated by a user that there is time for new components or consumables to be ordered. A process needs to be implemented quickly, availability data 768 may allow for constraint selection model to ignore any out of stock, or low stock consumables when selecting process control parameters.

In some embodiments datastore 760 also includes parameters relevant to industrial process unit 710, for example specifically actuator parameter 772, as well substrate parameter 774. For example, substrate parameter 774 may include whether or not a particular substrate has good adhesion with a given adhesive composition. Datastore 760 may also include other suitable information 778.

For example, model 730 could consider Computer Aided Drawing (CAD) files from users. This could carry information relevant to substrate type and joint design. The user could upload a CAD file and the model would then consider that information first before asking follow-up questions. This would greatly increase the quality of output and reduce the effort of the user. Additionally, in some embodiments, process design system 710 is incorporated into a CAD software.

Certain products have “simple” rules of thumb that can disqualify them from selection. For example, based a CAD model, a surface area of the bond area can be calculated, as well as and a force or stress will be applied. Some CAD models also note the substrate materials. 3D models can also show allowed movement and constraints so the direction of stress could be known.

Additionally, the term “CAD” is used broadly here and may refer to a 3D model alone, or with additional information. For example, a Finite Element Analysis (FEA) model may be built on top of a 3D model of a structure, which may allow for better prediction of stresses/strains/applied forces, etc.

Datastore 760 may also include Material Data Cards (MDC) of consumable properties 762 in a file that can be imported into Finite Element Analysis (FEA) software. FEA software takes a basic CAD model and applies a mesh to the design so that strains and stresses can be calculated numerically. Model 730, in some embodiments, integrates with the MDC into FEA software as a plug-in and/or library of materials.

In some embodiments, a user may build a typical CAD model, and provide it with a stored MDC, FEA software, and model 730 provide process parameter values and/or additional constraint requests.

It is expressly contemplated that in embodiments herein, a choice of which consumable to use is a parameter of interest for the constraint selection model 730. For example, a user of an adhesive dispenser is not asked to select a particular adhesive, instead constraint selection model 730 selects an adhesive as part of a set of process control variables for the user.

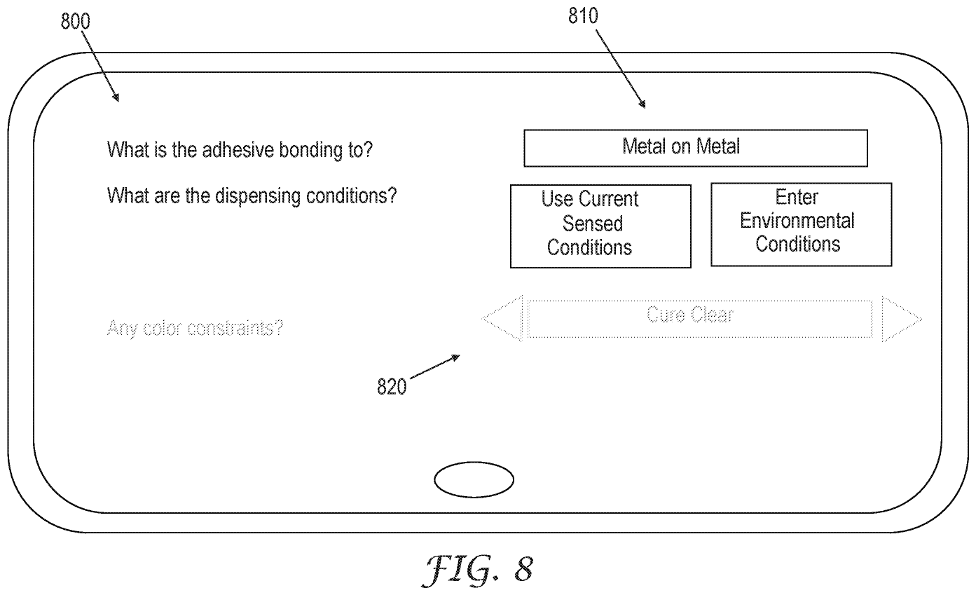

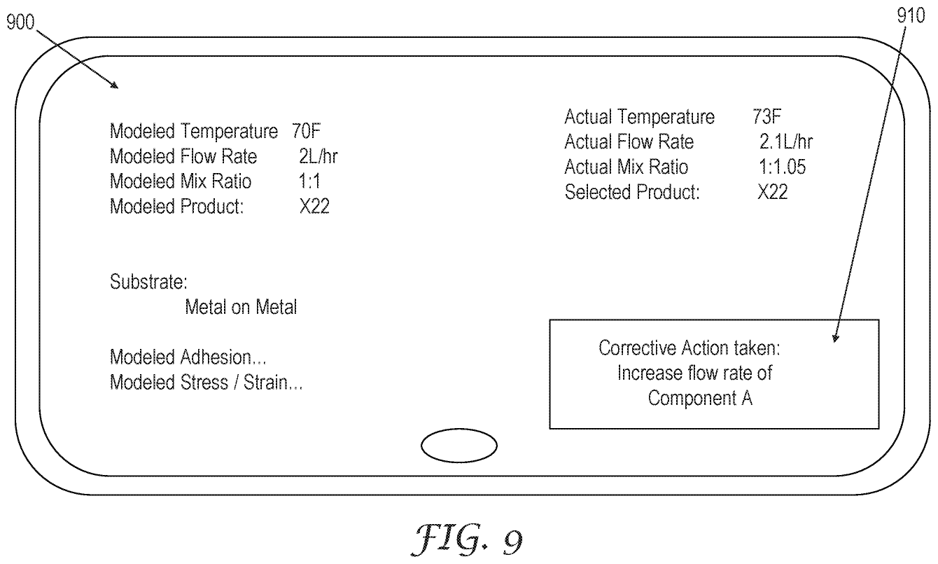

FIGS. 8-9 illustrate example user interfaces that may be presented to a process designer in accordance with embodiments herein. However, it is expressly contemplated that user interfaces 800 and 900 are presented for example purposes only. In some embodiments, a user device does not include a display, or a different user interface could be presented.

As illustrated in FIG. 8, two different types of constraint queries are illustrated. Constraint queries 810 maybe queries actually presented to a user, either through the display format illustrated in FIG. 8, or through another suitable mechanism, such as natural language, etc. Fixed constraint queries 820, on the other hand, are illustrated in FIG. 8 is grayed out, such that a user cannot interact with them in some embodiments. Fixed constraint queries 820 may be illustrated on a user interface 800, but in a manner that communicate to the user that they cannot be changed, or are set based on other higher-rated (e.g. more important) parameters of interest. However, it is expressly contemplated that such queries are not illustrated, or not presented to a user.

User interface 900 illustrates information that may be presented to a user while in experiment is undertaken with a set of process parameters selected by a model according to embodiments herein. As illustrated, a number of sensed parameter values, and parameter values selected by the model are illustrated, along with information about the substrate. Based on deviations in actual parameter values from modeled parameter values, corrective action 910 is illustrated. In some embodiments, corrective action 910 is taken automatically, and may or may not be presented to a user.

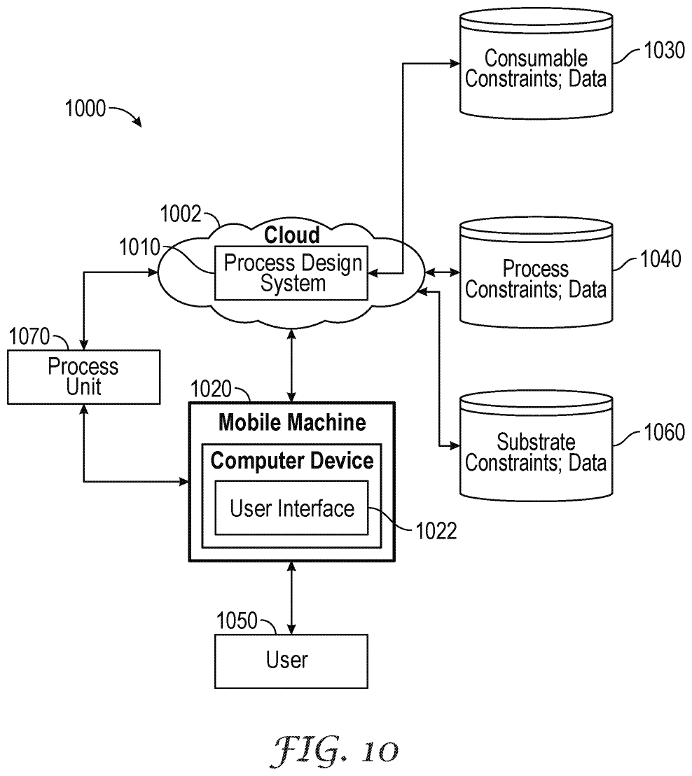

FIG. 10 illustrates a process design system architecture in which example embodiments can be implemented. FIG. 10 is a process design system Architecture 1000 illustrates one embodiment of an implementation of a process design system 1010. As an example, system 1000 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-9 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 10, some items are similar to those shown in earlier figures. FIG. 10 specifically shows that a system 1010 can be located at a remote server location 1002. Therefore, computing device 1020 accesses those systems through remote server location 1002. Operator 1050 can use computing device 1020 to access user interfaces 1022 as well.

FIG. 10 shows that it is also contemplated that some elements of systems described herein are disposed at remote server location 1002 while others are not. By way of example, storage 1030, 1040 or 1060 or process unit 1070 can be disposed at a location separate from location 1002 and accessed through the remote server at location 1002. Regardless of where they are located, they can be accessed directly by computing device 1020, using system 1010, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

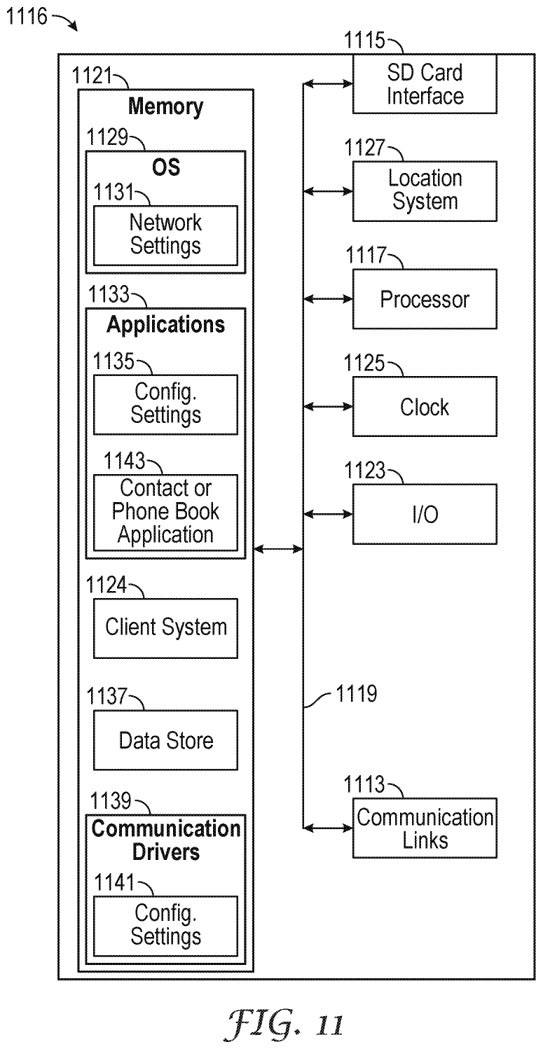

FIGS. 11-13 illustrate example devices that can be used in the embodiments shown in previous Figures. FIG. 11 illustrates an example mobile device that can be used in the embodiments shown in previous Figures. FIG. 11 is a simplified block diagram of one illustrative example of a handheld or mobile computing device that can be used by a user of systems and methods discussed herein. For example, the present system (or parts of it) can be deployed locally on device 1116, or an application 1133 may access a system or initiate a method described herein using a communication link 1113. For instance, a mobile device can be deployed in the operator compartment of computing device for use in generating, processing, or displaying the data.

FIG. 11 provides a general block diagram of the components of a mobile cellular device 1116 that can run some components shown and described herein. Mobile cellular device 1116 interacts with them or runs some and interacts with some. In the device 1116, a communications link 1113 is provided that allows the handheld device to communicate with other computing devices and under some embodiments provides a channel for receiving information automatically, such as by scanning. Examples of communications link 1113 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1115. Interface 1115 and communication links 1113 communicate with a processor 1117 (which can also embody a processor) along a bus 1119 that is also connected to memory 1121 and input/output (I/O) components 1123, as well as clock 1125 and location system 1127.

I/O components 1123, in one embodiment, are provided to facilitate input and output operations and the device 1116 can include input components such as buttons, touch sensors, optical sensors, microphones, touch screens, proximity sensors, accelerometers, orientation sensors and output components such as a display device, a speaker, and or a printer port. Other I/O components 1123 can be used as well.

Clock 1125 illustratively comprises a real time clock component that outputs a time and ate. It can also provide timing functions for processor 1117.

Illustratively, location system 1127 includes a component that outputs a current geographical location of device 1116. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1121 stores operating system 1129, network settings 1131, applications 1133, application configuration settings 1135, data store 1137, communication drivers 1139, and communication configuration settings 1141. Memory 1121 can include all types of tangible volatile and non-volatile computer-readable memory devices. It can also include computer storage media (described below). Memory 1121 stores computer readable instructions that, when executed by processor 1117, cause the processor to perform computer-implemented steps or functions according to the instructions. Processor 1117 can be activated by other components to facilitate their functionality as well. It is expressly contemplated that, while a physical memory store 1121 is illustrated as part of a device, that cloud computing options, where some data and/or processing is done using a remote service, are available.

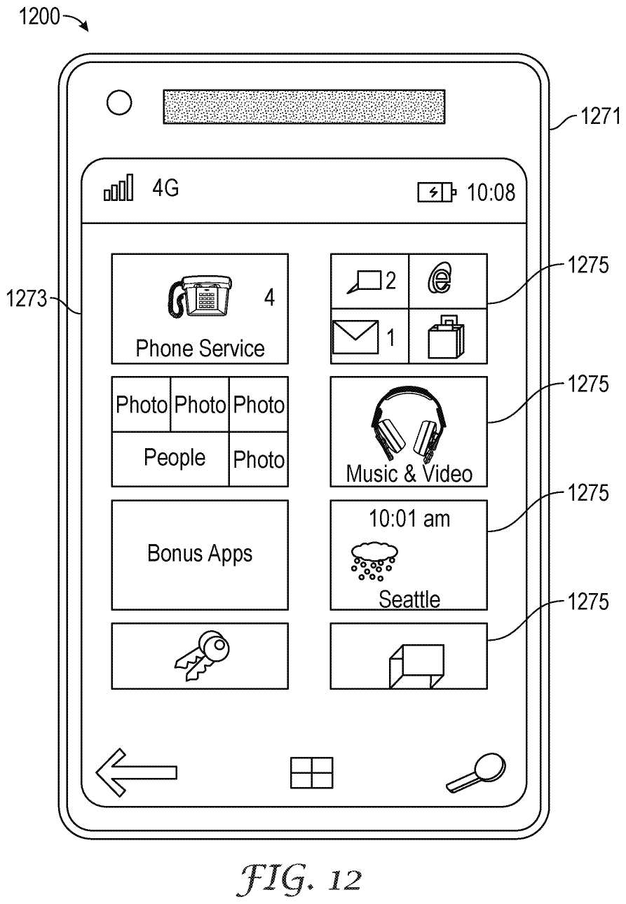

FIG. 12 shows that the device can also be a smart phone 1271. Smart phone 1271 has a touch sensitive display 1273 that displays icons or tiles or other user input mechanisms 1275. Mechanisms 1275 can be used by a user to run applications, make calls, perform data transfer operations, etc. In general, smart phone 1271 is built on a mobile operating system and offers more advanced computing capability and connectivity than a feature phone. Note that other forms of the devices are possible.

However, while FIG. 12 illustrates an embodiment where a device 1w00 is a smart phone 1271, it is expressly contemplated that a display may be presented on another comping device.

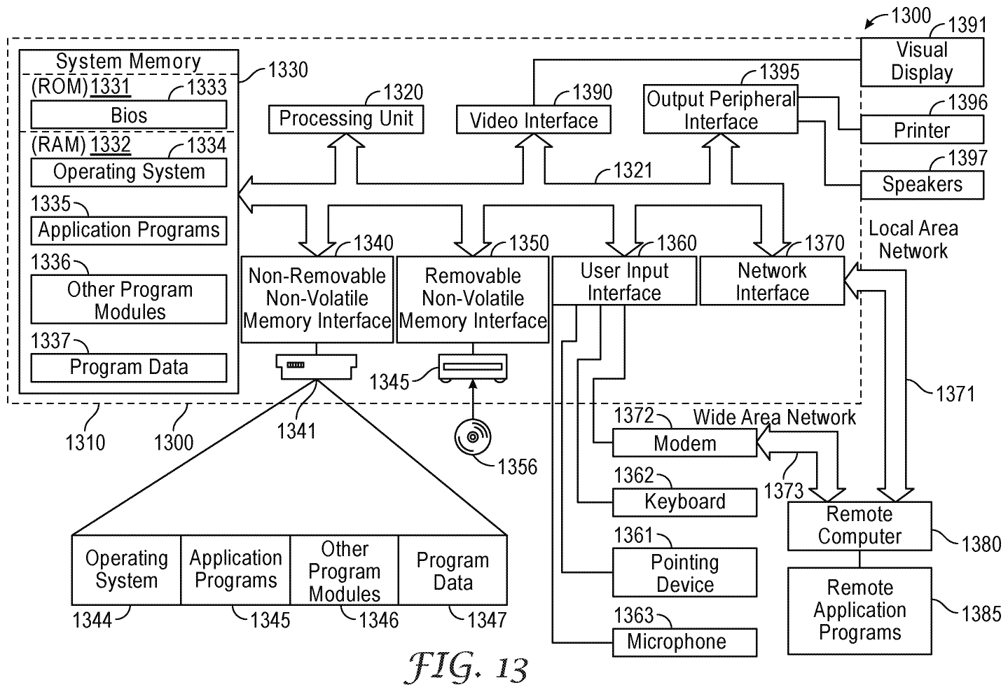

FIG. 13 is one example of a computing environment in which elements of systems and methods described herein, or parts of them (for example), can be deployed. With reference to FIG. 13, an example system for implementing some embodiments includes a general-purpose computing device in the form of a computer 1310. Components of computer 1310 may include, but are not limited to, a processing unit 1320 (which can comprise a processor), a system memory 1330, and a system bus 1321 that couples various system components including the system memory to the processing unit 1320. The system bus 1321 may be any of several types of bus structures including a memory bus or memory controller, a peripheral bus, and a local bus using any of a variety of bus architectures. Memory and programs described with respect to systems and methods described herein can be deployed in corresponding portions of FIG. 10.

Computer 1310 typically includes a variety of computer readable media. Computer readable media can be any available media that can be accessed by computer 1310 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1310. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1330 includes computer storage media in the form of volatile and/or nonvolatile memory such as read only memory (ROM) 1331 and random-access memory (RAM) 1332. A basic input/output system 1333 (BIOS) containing the basic routines that help to transfer information between elements within computer 1310, such as during start-up, is typically stored in ROM 1331. RAM 1332 typically contains data and/or program modules that are immediately accessible to and/or presently being operated on by processing unit 1320. By way of example, and not limitation, FIG. 13 illustrates operating system 1334, application programs 1335, other program modules 1336, and program data 1337.

The computer 1310 may also include other removable/non-removable and volatile/nonvolatile computer storage media. By way of example only, FIG. 13 illustrates a hard disk drive 1341 that reads from or writes to non-removable, nonvolatile magnetic media, nonvolatile magnetic disk 1352, an optical disk drive 1355, and nonvolatile optical disk 1956. The hard disk drive 1341 is typically connected to the system bus 1321 through a non-removable memory interface such as interface 1340, and optical disk drive 1355 are typically connected to the system bus 1321 by a removable memory interface, such as interface 1350.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 1310. In FIG. 13, for example, hard disk drive 1341 is illustrated as storing operating system 1344, application programs 1345, other program modules 1346, and program data 1347. Note that these components can either be the same as or different from operating system 1334, application programs 1335, other program modules 1336, and program data 1337.

A user may enter commands and information into the computer 1310 through input devices such as a keyboard 1362, a microphone 1363, and a pointing device 1361, such as a mouse, trackball or touch pad. Other input devices (not shown) may include a joystick, game pad, satellite receiver, scanner, or the like. These and other input devices are often connected to the processing unit 1320 through a user input interface 1360 that is coupled to the system bus but may be connected by other interface and bus structures. A visual display 1391 or other type of display device is also connected to the system bus 1321 via an interface, such as a video interface 1390. In addition to the monitor, computers may also include other peripheral output devices such as speakers 1397 and printer 1396, which may be connected through an output peripheral interface 1395.

The computer 1310 is operated in a networked environment using logical connections, such as a Local Area Network (LAN) or Wide Area Network (WAN) to one or more remote computers, such as a remote computer 1380.

When used in a LAN networking environment, the computer 1310 is connected to the LAN 1371 through a network interface or adapter 1370. When used in a WAN networking environment, the computer 1310 typically includes a modem 1372 or other means for establishing communications over the WAN 1373, such as the Internet. In a networked environment, program modules may be stored in a remote memory storage device. FIG. 13 illustrates, for example, that remote application programs 1385 can reside on remote computer 1380.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device. The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

An industrial process design system is presented that includes a process constraint retriever that receives an indication of a parameter constraint for an industrial process. The system also includes a parameter selector that retrieves a set of potential process design parameters for the industrial. The process the parameter selector analyzes the parameter constraint indication. Based on the set of potential process design parameters, and constraint indication analysis, the parameter selector selects a next parameter of interest. The parameter selector generates a constraint query for the selected next parameter. The parameter selector iteratively analyzes received parameter constraint information, selects a new parameter of interest, and generates a new constraint query. The system also includes a process design generator that generates a process design parameter set based on the constraint queries generated by the parameter selector.

The system of claim 1 may be implemented such that it includes a query communicator that communicates the generated query.

The system may be implemented such that the query communicator comprises a graphical user interface generator that generates a graphical user interface comprising the generated query.

The system may be implemented such that the query communicator comprises a natural language generator.

The system may be implemented such that the process constraint retriever receives the constraint indication from a sensor.

The system may be implemented such that the sensor is a temperature sensor, pressure sensor, flow rate sensor, mix ratio sensor, position sensor, distance sensor, or reflectivity sensor.

The system may be implemented such that the sensor is part of the industrial process.

The system may be implemented such that the sensor sends sensor signals to a datastore, which the process constraint retriever accesses.

The system may be implemented such that the parameter constraint indication is a substrate composition.

The system may be implemented such that the parameter constraint indication is a use condition for a product of the industrial process.

The system may be implemented such that the industrial process is an adhesive dispensing process, and wherein the use condition is a temperature range.

The system the industrial process is an adhesive dispensing process, and wherein the parameter constraint information is a second substrate that an adhesive couples to a first substrate with the substrate composition.

The system may be implemented such that the parameter selector designates at least one of the set of potential design process parameters as constrained based on the received indication. Based on the constrained parameter, the parameter selector selects the new parameter of interest.

The system may be implemented such that the parameter selector designates at least one of the set of potential design process parameters as constrained based on the received indication. Based on the constrained parameter, the parameter selector changes a weight of a second of the set of potential process design parameters.

A method of generating a set of process design parameters for an industrial process is presented that includes iteratively receiving an indication of a constraint for a first parameter in the set of process design parameters, based on the received constraint indication, selecting a second parameter in the set of process design parameters, and generating a constraint query for the second parameter. The steps of receiving, selecting and generating repeat until the set of process design parameters is fully constrained. The method also includes generating a process design test command comprising the set of process design parameters.

The method may be implemented such that it includes communicating the process design test command to the industrial process, such that the industrial process implements the set of process design parameters.

The method may be implemented such that it includes communicating the process design test command to a graphical user interface.

The method may be implemented such that generating the constraint query comprises generating a natural language-based query.

The method may be implemented such that the constraint indication is received by a microphone.

The method may be implemented such that selecting the second parameter comprises designating a third parameter as constrained.

The method may be implemented such that selecting the second parameter comprises changing a weight of the second parameter relative to a third parameter.

The method may be implemented such that the third parameter is an adhesive color, and the adhesive color is set based on a received substrate material.

The method may be implemented such that the received constraint indication is an operating temperature.

The method may be implemented such that the industrial process is an adhesive dispensing operation, and the process design test command is communicated to an adhesive compounding unit.

The method may be implemented such that the received constraint indication is feedback based on an adhesive compounding attempt.

An industrial process design system is presented that includes an industrial process unit having a set of configurable parameters. The system also includes a communication component that is configured to receive a parameter constraint indication for a first parameter in the set of configurable parameters. The system also includes a parameter selection module that, based on the received parameter constraint indication, adjusts the set of configurable parameters by, for a second parameter: changing a weight associated with the second parameter in the set, designating the second parameter as fully constrained, or generating a query related to the second parameter, wherein the query is communicated using the communication component. The parameter selection module repeatedly adjusts the set of configurable parameters until a constrained set of parameters for the industrial process is generated. The system also includes a controller that communicates the constrained set of parameters to a device.

The system may be implemented such that the device is the industrial process.

The system may be implemented such that the device is a computing device with a display.

The system may be implemented such that the parameter constraint indication is received from an I/O device.

The system may be implemented such that the parameter constraint indication is a received natural language signal from a microphone.

The system may be implemented such that the parameter constraint indication is received from a sensor.

The system may be implemented such that the sensor is associated with the industrial process unit.

The system may be implemented such that the sensor is an ambient environment sensor.

The system may be implemented such that the parameter reduces a weight associated with the second parameter if the received constraint indication indicates that the first parameter is a higher priority than the second parameter.

The system may be implemented such that the second parameter is designated as constrained if only one option remains.

The system may be implemented such that, if the parameter selection module detects that no options remain for the second parameter, the parameter selection module overrides the received constraint input.

The system may be implemented such that the industrial process unit is an adhesive dispensing unit.

The system may be implemented such that the received constraint information is a product use specification, comprising: a use temperature, a substrate, or a minimum adhesion.

The system may be implemented such that the received constraint information is a dispenser limitation, comprising: a maximum flow rate, a mixing ratio limitation, or an operating temperature.

The system may be implemented such that the second parameter is a user preference, including: an adhesive thickness, an adhesive color or an adhesive cost.

The system may be implemented such that the first parameter is a numerically expressed parameter and the second parameter is a non-numerically expressed parameter.

An adhesive dispensing design system is presented that includes an adhesive dispensing unit having a set of configurable parameters. The system also presents a communication component that is configured to receive a parameter constraint indication for a first parameter in the set of configurable parameters. The system also includes a parameter selection module that, based on the received parameter constraint indication, adjusts the set of configurable parameters by, for a second parameter: changing a weight associated with the second parameter in the set, designating the second parameter as fully constrained, or generating a query related to the second parameter, wherein the query is communicated using the communication component. The parameter selection module repeatedly adjusts the set of configurable parameters until a constrained set of parameters for the industrial process is generated. The system also includes a controller that communicates the constrained set of parameters to a device.

The system may be implemented such that the device is the adhesive dispensing unit. The system may be implemented such that the device is a computing device with a display.

The system may be implemented such that the parameter constraint indication is received from an I/O device.

The system may be implemented such that the parameter constraint indication comprises a received natural language signal from a microphone.

The system may be implemented such that the parameter constraint indication is received from a sensor.

The system may be implemented such that the sensor is associated with the adhesive dispensing unit.

The system may be implemented such that the sensor is an ambient environment sensor.

The system may be implemented such that the parameter reduces a weight associated with the second parameter if the received constraint indication indicates that the first parameter is a higher priority than the second parameter.

The system may be implemented such that the second parameter is designated as constrained if only one option remains.

The system may be implemented such that, if the parameter selection module detects that no options remain for the second parameter, the parameter selection module overrides the received constraint input.

The system may be implemented such that the received constraint information is a product use specification, comprising: a use temperature, a substrate, or a minimum adhesion.

The system may be implemented such that the received constraint information is a dispenser limitation, comprising: a maximum flow rate, a mixing ratio limitation, or an operating temperature.

The system may be implemented such that the second parameter is a user preference, comprising: an adhesive thickness, an adhesive color or an adhesive cost.

The system may be implemented such that the first parameter is a numerically expressed parameter and the second parameter is a non-numerically expressed parameter.

### EXAMPLES

These examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed considering the number of reported significant digits and by applying ordinary rounding.

Adhesives provide many benefits over traditional mechanical fasteners when joining two substrates together. However, adhesives can also be more complex to use in an industrial process because of the material properties, the process conditions, and even the effect of the process conditions on the material properties. Each joining process has unique features which makes it difficult to optimize the process in full. In many cases, it is not possible to fully maximize all aspects of the process because shifting one process parameter will affect optimal settings of other process parameters. Traditional systems and methods that attempt to account for the complexity optimizing parameters tend to be either rigid in their approach or limited in their effect.

Take for example an engineer attempting to join ABS plastic to steel. ABS plastic is a class of materials that contains acrylonitrile, butadiene, and styrene. The definition of ABS does not include the ratios of these components, so there can be a large variety of what ABS means from a mechanical and chemical perspective. In addition, ABS is often molded using mold release agents that are left on the surface after production which is important from a surface science perspective. Finally, ABS is a commodity material which in many cases means that an end user ordering material through their channels could receive different materials with each order. These differences illustrates the complexity of optimizing an adhesive bonding process because these factors can greatly affect how a given adhesive performs on ABS as well as how best to process the adhesive for use on ABS.

In this example, the engineer enters the substrates “Steel” and “ABS” into a graphical user interface (GUI) which is sent as the first process constraint. The system understands the complexity behind ABS so it prioritizes the next parameter to be whether or not the ABS is molded. The engineer answers that it is molded, so the system then chooses to collect the next parameter constraint asking whether solvents can be used in their facility. The engineer then confirms that their EHS does not allow solvents to be used and this further constrains the potential adhesive materials that may be appropriate for this application. The system may request additional parameters such as processing open time for the adhesive, color of the adhesive, or other parameters.

Traditional systems would likely fail with this attempt for a number of reasons. One reason could be if certain critical information is not gathered, the suggestion will lead to an erroneous suggestion (e.g. one that requires solvent cleaning prior to use, if solvent use is not prompted as a parameter constraint). They could also fail because they collected conflicting constraints where no solution meets all constraints given, or they could err on the side of not allowing the user to give all required constraints leading to a solution that does not meet end use requirements.

This system treats each parameter constraint as conditional so that it can receive conflicting constraints and then decide how best to proceed and how to optimize within the given constraints. For example, the engineer may specify that the material should be black and that it needs to join the ABS and steel with no solvent cleaning. If there is no black material that will perform, but a clear material is available that otherwise meets the constraints, this clear material may be offered with detail on why it was chosen. It is also known by the system that ABS is a variable material, so it will communicate that to the engineer by giving a confidence level of the solution which further aids the engineers in designing the process.

Furthermore, once the candidate adhesive material is chosen, the system initiates delivery of the material to the engineer with instructions of how to setup, use, and test the adhesive. In this example, the user has an adhesive dispenser so the system further provides instructions to calibrate and test with that dispenser. Given the rheological properties of the two-part adhesive, only two static mixer nozzles will adequately mix the adhesive and yield a proper cure. The system notifies the engineer that these components will be required. Once the engineer tests the samples, they input the results into the system, and the system suggests optimal dispensing flow rate ranges given that input. If there is a temperature sensor on the dispenser, that information can be considered by the system as it affects the dispensability of the adhesive and the resultant range of processability.

In another example, the system starts by loading a Computer-aided Design (CAD) file into the system. The system ingests the parameter constraints of geometry and substrate materials from the file. Given the surface area of the substrates, the system decides that a double-sided tape could be a candidate for this application. To further constrain the problem, it verbally asks the user, “What is the maximum temperature that this joint will experience?” The user verbally replies, “400 F”. The system similarly obtains the constraints for the time spent at this temperature and whether the joint needs to be flexible or rigid. Given the results, it does not require any more information and so suggests a particular double sided tape to be tested. Double sided tapes are pressure sensitive adhesives (PSA), so they need to be activated by pressing them firmly onto the substrate-merely touching the substrate is not sufficient to form a strong bond.

This PSA requires a minimum of 15 psi of pressure between the tape and the substrate. This is complicated by the fact that production process equipment is set to deliver force and not pressure. Also, when the tape is between two substrates, the pressure generated on the top of the sandwich may not be the same pressure that is acting on the PSA because of the geometry of the bond area which is often not the same shape as the substrate as a whole. Given that the system has the CAD model, it is able to calculate the required pressure and convert that to a force setting that can be used with automatic processing equipment. Each PSA has temperature use ranges and also preferred durations for pressure application. These are set as process parameters that impact the range of use conditions and process settings such as rate of application and dwell time prior to stressing. The engineer uses these process parameters and provides feedback to the system which is further used to refine that process.

1. An industrial process design system comprising:
a process constraint retriever that receives an indication of a parameter constraint for an industrial process;
a parameter selector that retrieves a set of potential process design parameters for the industrial process, wherein the parameter selector:
analyzes the parameter constraint indication;
based on the set of potential process design parameters, and constraint indication analysis, selects a next parameter of interest;
generates a constraint query for the selected next parameter; and
wherein the parameter selector iteratively analyzes received parameter constraint indication, selects a new parameter of interest, and generates a new constraint query; and
a process design generator that generates a process design parameter set based on the constraint queries generated by the parameter selector.

2. The system of claim 1, and further comprising:
a query communicator that communicates the generated query.

3. The system of claim 2, wherein the query communicator comprises a graphical user interface generator that generates a graphical user interface comprising the generated query.

4. The system of claim 1, wherein the process constraint retriever receives the constraint indication from a sensor.

5. The system of claim 4, wherein the sensor is a temperature sensor, pressure sensor, flow rate sensor, mix ratio sensor, position sensor, distance sensor, or reflectivity sensor.

6. The system of claim 1, wherein the parameter constraint indication is a substrate composition.

7. The system of claim 1, wherein the parameter constraint indication is a use condition for a product of the industrial process.

8. The system of claim 7, wherein the use condition is a temperature range.

9. The system of claim 6, wherein the parameter constraint indication is a first substrate material.

10. The system of claim 1, wherein the parameter selector designates at least one of the set of potential design process parameters as constrained based on the received indication and wherein, based on the constrained parameter, the parameter selector selects the new parameter of interest.

11. The system of claim 1, wherein the parameter selector designates at least one of the set of potential design process parameters as constrained based on the received indication and wherein, based on the constrained parameter, the parameter selector changes a weight of a second of the set of potential process design parameters.

12. A method of generating a set of process design parameters for an industrial process for adhesive dispensing, the method comprising:
iteratively:
receiving an indication of a constraint for a first parameter in the set of process design parameters for adhesive dispensing;
based on the received constraint indication, selecting a second parameter in the set of process design parameters;
generating a constraint query for the second parameter; and
wherein the steps of receiving, selecting and generating repeat until the set of process design parameters is fully constrained; and
generating a process design test command comprising the set of process design parameters.

13-20. (canceled)

21. An industrial process design system comprising:
an industrial process unit having a set of configurable parameters dispensing;
a communication component that is configured to receive a parameter constraint indication for a first parameter in the set of configurable parameters;
a parameter selection module that, based on the received parameter constraint indication, adjusts the set of configurable parameters by, for a second parameter:
changing a weight associated with the second parameter in the set;
designating the second parameter as fully constrained; or
generating a query related to the second parameter, wherein the query is communicated using the communication component; and
wherein the parameter selection module repeatedly adjusts the set of configurable parameters until a constrained set of parameters for the industrial process is generated; and
a controller that communicates the constrained set of parameters to a device.

22-30. (canceled)

31. An adhesive dispensing design system comprising:
an adhesive dispensing unit having a set of configurable parameters;
a communication component that is configured to receive a parameter constraint indication for a first parameter in the set of configurable parameters;
a parameter selection module that, based on the received parameter constraint indication, adjusts the set of configurable parameters by, for a second parameter:
changing a weight associated with the second parameter in the set;
designating the second parameter as fully constrained; or
generating a query related to the second parameter, wherein the query is communicated using the communication component; and
wherein the parameter selection module repeatedly adjusts the set of configurable parameters until a constrained set of parameters for the industrial process is generated; and
a controller that communicates the constrained set of parameters to a device.

32. The system of claim 31, wherein the device is the adhesive dispensing unit or a computing device with a display.

33. The system of claim 31, further comprising the device, wherein the device is configured to implement the constrained set of parameters.

34. The system of claim 31, wherein the parameter constraint indication is received from a sensor associated with the adhesive dispensing unit, wherein the sensor is an ambient environment sensor.

35. The system of claim 31, wherein the parameter reduces a weight associated with the second parameter if the received constraint indication indicates that the first parameter is a higher priority than the second parameter.

36. The system of claim 31, wherein the received constraint indication is a product use specification, comprising: a use temperature, a substrate, or a minimum adhesion.

37. The system of claim 31, wherein the first parameter is a numerically expressed parameter and the second parameter is a non-numerically expressed parameter.
